(19) United States
(12) Patent Application Publication
(10) Pub. No.: US 2003/0173835 A1
(43) Pub. Date: Sep. 18, 2003

(54) Vibrating linear actuator and portable information apparatus having the same

(76) Inventors: Noriyoshi Nishiyama, Osaka (JP); Kazuhiro Shimoda, Osaka (JP); Shinichiro Kawano, Osaka (JP); Toshiyuki Iwahori, Tottori (JP)

Correspondence Address: LAWRENCE E. ASHERY, SUITE 301, ONE WESTLAKES, BERWYN, P.O. BOX 980, VALLEY FORGE, PA, 19482-0980, US

(21) Appl. No.: 10/316,626

(22) Filed: Dec. 11, 2002

(30) Foreign Application Priority Data
Dec. 21, 2001 (JP) 2001-389135

(51) Int. Cl. H02K 41/00

(52) U.S. Cl. 310/12

(57) ABSTRACT

A slim and efficient vibrating linear actuator includes a stator which sandwiches a coil generating vibrating magnetic field, and a first teeth section and a second teeth section. A mover, including a permanent magnet, is linked to the stator by elastic bodies and energized substantially to a midpoint between the first and second teeth sections. When the mover faces both of the first teeth section and the second teeth section, electric current is supplied to the coil, and when the mover faces only one of the first teeth section or the second teeth section, no electric current is supplied to the coil. This structure allows the vibrating linear actuator to be slimmed down and operate efficiently. A portable information apparatus employing this actuator can be slimmed down and work efficiently.

### TECHNICAL FIELD

The present invention relates to a slim vibrating linear actuator and a portable information apparatus equipped with the same actuator.

Background Art

Portable information apparatuses such as cellular phones employ a vibration generating device for paging. A cylindrical motor equipped with an unbalance weight has been used as the vibration generating device. However, this cylindrical motor has a ceiling to be slimmed down, and causes a bottleneck in automating the surface mounting. A coin-shaped motor equipped with an unbalance weight is commercialized in order to overcome those problems; however, it vibrates in parallel with the printed circuit board, so that the vibration is not well sensed by a user. A button-shaped linear actuator is proposed to vibrate vertically to the printed circuit board; however, it is difficult to generate large exciting force and to be further slimmed down.

FIG. 18 shows a structure of a conventional vibrating linear actuator, which is outlined hereinafter. Vibrating linear actuator 101 comprises mover 104A and stator 103A. Mover 104A includes polygonal outer yoke 104 and magnet 105 placed inside yoke 104. Stator 103A is placed inside mover 104A and includes cylindrical inner yoke 103 and coil 102 wound on inner yoke 103. Inner yoke 103 has first teeth section 131 and second teeth section 132 and is opposite to magnet 105 of mover 104A.

A thickness of mover 104A is determined such that both of upper teeth 131 and lower teeth 132 face magnet 105 of mover 104A even when mover 104A moves to the top dead point or the bottom dead point. In other words, the dimensional relation of L101>L102+L104 is satisfied. Therefore, attraction and repulsion are produced at upper teeth 131 and lower teeth 132, and thrust force proportionate to electric current can be always obtained as shown in FIG. 19.

In the case of using the vibrating linear actuator used as a paging vibrator of a portable information apparatus such as a cellular phone, the actuator is required to be slimmed down because the market requests cellular phones be slimmer and slimmer. On the other hand, since the actuator works as a paging vibrator, the actuator needs a greater magnitude of vibration while it is desirably slimmed down. For this purpose, mover 104A must vibrates a large amount. A greater magnitude of vibration within a limit of thickness requires mover 104A to be further slimmed down, so that when mover 104A moves near the top dead point or the bottom dead point, magnet 105 of mover 104A fails to face either one of teeth 131 or teeth 132. In such a status, powering coil 102 does not result in efficient attraction and repulsion with respect to mover 104A. As a result, thrust force responsive to the electric current value is not obtainable as shown in FIG. 20, which only invites loss.

### DISCLOSURE OF INVENTION

A vibrating linear actuator of the present invention comprises the following elements:

a mover including a magnet;

a stator including a coil that generates vibrating magnetic field to the mover; and

elastic bodies that link the stator to the mover. The stator sandwiches the coil, and has first teeth section and second teeth section. When the mover faces both of the first teeth section and the second teeth section, electric current runs through the coil, and when the mover faces either one of the first teeth section or the second teeth section, the electric current does not run through the coil.

In the vibrating linear actuator of the present invention, in the case that a thickness of a mover that has a permanent magnet is less than those of the first and second teeth sections, and when at least a part of the mover is within a space between the first and second teeth sections, electric current runs through a coil. When the mover faces only either one of the first teeth section or the second teeth section, the electric current does not run through the coil.

The present invention further discloses a portable information apparatus that employs the vibrating linear actuator discussed above.

According to the present invention, a slim and efficient vibrating linear actuator and portable information apparatus can be obtained, so that portability can be improved and longer-hour drive by a battery is achievable.

### BRIEF DESCRIPTION OF THE DRAWINGS

FIG. 1A shows a sectional view of a vibrating linear actuator in accordance with a first exemplary embodiment of the present invention.

FIG. 1B shows a sectional view in a radial direction of the same actuator.

FIG. 2A shows a bottom view of the same actuator.

FIG. 2B shows a perspective view of the same actuator.

FIG. 3A shows a top view of the same actuator mounted on a board.

FIG. 3B shows a lateral view of the same actuator mounted on the board.

FIG. 4 shows a top view of a portable information apparatus.

FIG. 5 is a sectional view for illustrating the first embodiment.

FIG. 6 is a sectional view for illustrating the first embodiment.

FIG. 7 shows waveforms of electric current and thrust force in accordance with the first exemplary embodiment.

FIGS. 8A, 8B, 8C and 8D show relations between a mover's position and a timing of power-on in accordance with the first exemplary embodiment.

FIGS. 9A, 9B, 9C and 9D show relations between a mover's position and a timing of power-on in accordance with the first exemplary embodiment.

FIGS. 10A, 10B, 10C and 10D show relations between a mover's position and a timing of power-on in accordance with the first exemplary embodiment.

FIG. 11 shows a circuit diagram that performs full-wave driving in rectangular wave in accordance with the first exemplary embodiment.

FIG. 12 shows a circuit diagram that performs half-wave driving in rectangular wave in accordance with the first exemplary embodiment.

FIG. 13 shows a sectional view of a vibrating linear actuator in accordance with a second exemplary embodiment of the present invention.

FIG. 14 shows a sectional view of a vibrating linear actuator in accordance with the second exemplary embodiment.

FIG. 15 shows waveforms of electric current and thrust force in accordance with the second exemplary embodiment.

FIGS. 16A, 16B, 16C and 16D show relations between a mover's position and a timing of power-on in accordance with the second embodiment.

FIGS. 17A, 17B, 17C and 17D show relations between a mover's position and a timing of power-on in accordance with the second embodiment.

FIG. 18 shows a sectional view of a conventional vibrating linear actuator.

FIG. 19 shows a waveform of electric current and thrust force in the conventional vibrating linear actuator.

FIG. 20 shows another waveform of electric current and thrust force in another conventional vibrating linear actuator.

### PREFERRED EMBODIMENT OF THE INVENTION

Exemplary embodiments of the present invention are demonstrated hereinafter with reference to the accompanying drawings.

Exemplary Embodiment 1

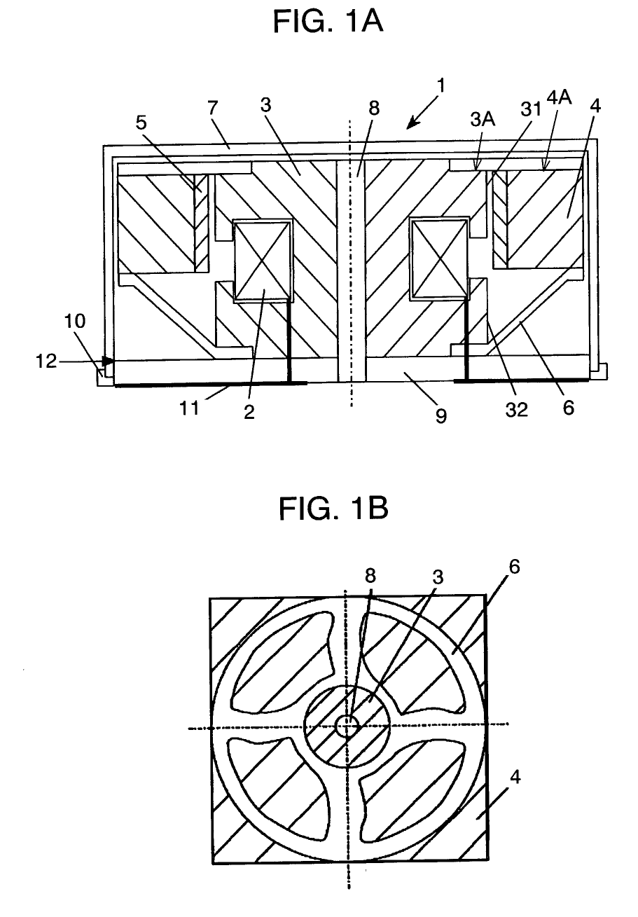

FIGS. 1A and 1B illustrate a structure of a vibrating linear actuator. Vibrating linear actuator 1 includes mover 4A and stator 3A. Mover 4A is equipped with polygonal outer-yoke 4 and magnet 5 placed inside yoke 4. Stator 3A is placed inside mover 4A and equipped with cylindrical inner-yoke 3 and coil 2 wound on inner yoke 3. Inner yoke 3 has first teeth section 31 and second teeth section 32 and faces magnet 5 of mover 4A. Space exists between first teeth section 31 and second teeth section 32.

Magnet 5 is magnetized, e.g., N pole at its inner wall and S pole at its outer wall, i.e., the inner wall and the outer wall are magnetized unipolar respectively and different poles from each other. Inner yoke 3 and outer yoke 4 are formed of metallic material made from green compact of magnetic powder, however; they can be formed of thin steel plates laminated radially (thin steel plates are laminated on shaft 8 radially).

Inner yoke 3 has shaft 8 at its center, and shaft 8 protrudes from a bottom plate of inner yoke 3. Inner yoke 3 is positioned with the protruding portion of shaft 8 and a recess of base 9, and fixed on base 9. A lower elastic body 6 is sandwiched by base 9 and inner yoke 3. Base 9 is made from heat-resistant resin of which glass transition temperature is not less than 90° C.

Elastic body 6 is formed of two thin leaf springs shaped like rings. An upper spring and a lower spring are available. When mover 4A moves downward from a balanced point, elastic body 6 moves mover 4A upward. When mover 4A moves upward from the balanced position, elastic body 6 moves mover 4A downward. In other words, elastic body 6 energizes mover 4A to be positioned at substantially the midpoint of stator 3A.

Coil 2 is electrically coupled to metallic land 11 extending from the bottom of base 9, and powered from land 11. Land 11 can be prepared on a top face of cover 7 instead of the bottom of base 9.

Cover 7 covers stator 3A and mover 4A, and is caulked to base 9 with cover-caulking section 10 prepared to base 9. Cover 7 protects the components inside of the actuator from touching other components outside the actuator or from damages when the actuator undergoes reflow-soldering. Cover 7 also helps handling of the actuator. Cover 7 is made from metal; however, it can be made from heat-resistant resin.

Actuator 1 discussed above flows the current supplied from land 11 to coil 2, thereby generating vibrating magnetic flux. This vibrating magnetic flux drives mover 4A. Land 11 is exposed from the bottom plate of base 9.

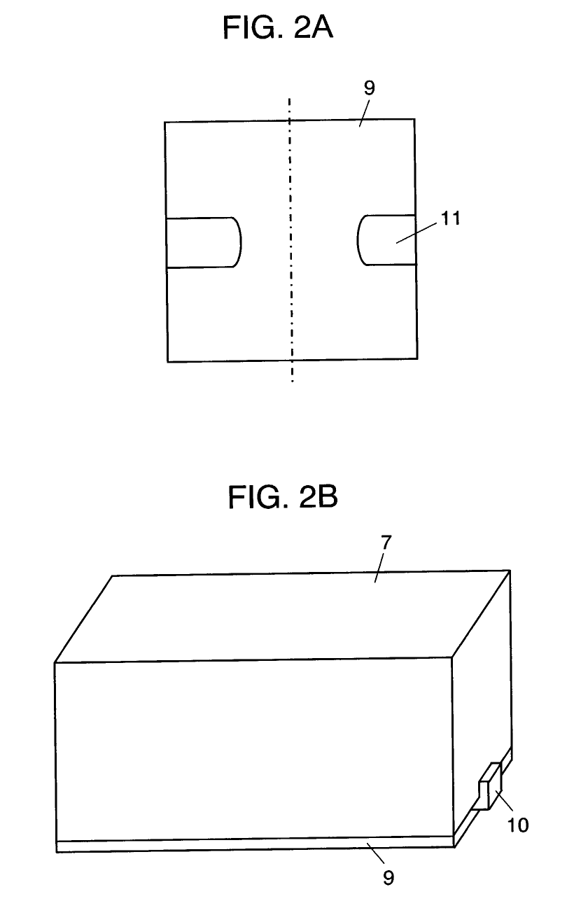

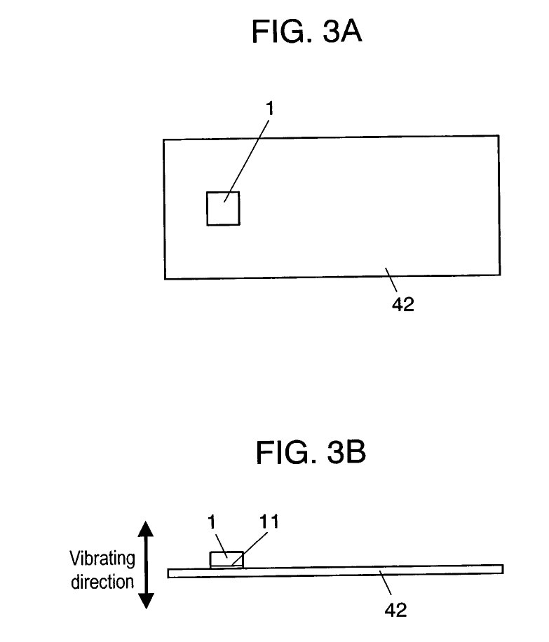

FIG. 2A shows a bottom view of the vibrating linear actuator, and FIG. 2B shows a perspective view of the same actuator. FIGS. 3A and 3B show the actuator mounted on board 42 of a portable information apparatus such as a cellular phone. Board 42 is a double-sided and multi-layered board, and a number of electronic components (not shown) are mounted at a high density.

Land 11 of actuator 1 is reflow-soldered to a land of board 42 equipped in the cellular phone. An actuator driving circuit is also provided to board 42 and controlled by exciting coil 2 via land 11.

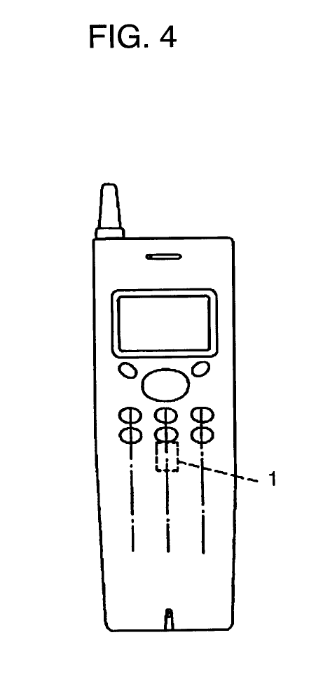

FIG. 4 shows an external view of the portable information apparatus, such as a cellular phone, including board 42.

In the foregoing vibrating linear actuator, mover 4A having magnet 5 vibrates up and down following the magnetic flux generated by coil 2. Elastic body 6, of which first end is fixed to the inner yoke and a second end is fixed to the mover, is provided on and beneath the mover, so that kinetic energy of mover 4A is taken out as vibration.

For instance, assume that magnet 5 is magnetized N pole at the inner wall, and when coil 2 is powered such that electric current flows clockwise viewed from the top of FIG. 1A, magnetic flux occurs downward. Thus first teeth section 31 positioned on upper side is excited S pole and second teeth section 32 positioned on lower side is excited N pole, so that mover 4A including magnet 5 of which inner wall is magnetized N pole is drawn upward. When coil 2 is powered in the reversal direction to the above, first teeth section 31 and second teeth section 32 are excited N pole and S pole respectively, so that mover 4A is drawn downward. As such, the supply of ac current to coil 2 vibrates mover 4A repeatedly following the frequency.

The vibrating linear actuator of the present invention works as a paging vibrator of a portable information apparatus such as a cellular phone, thus the actuator is required to be further slimmer. On the other hand, greater magnitude of vibration is demanded. In order to obtain greater magnitude of vibration, mover 4A should be further slimmed down.

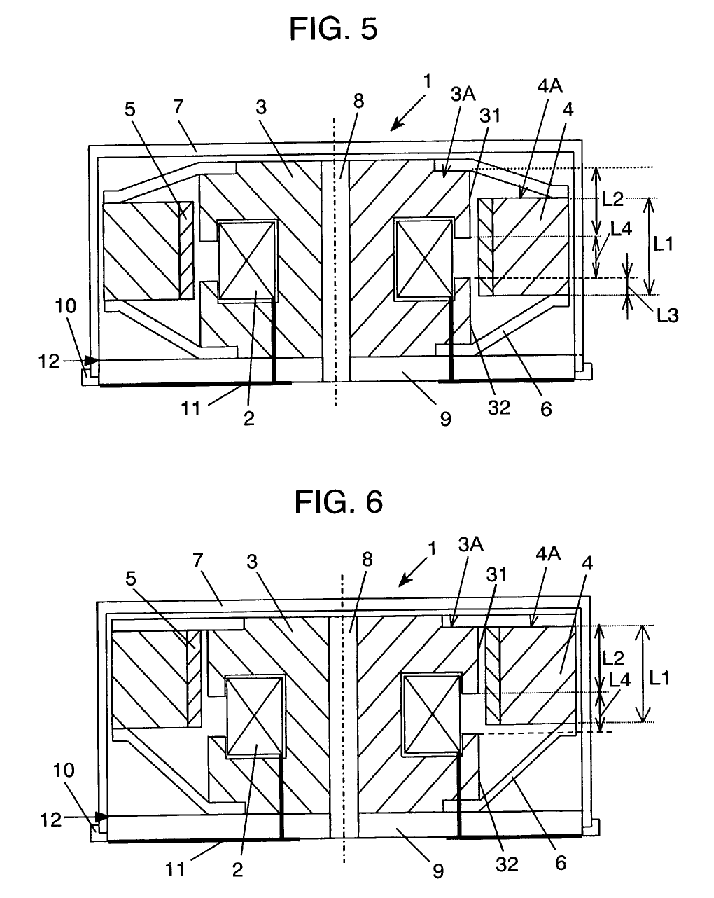

FIGS. 5 and 6 illustrate an operation of the present invention. FIG. 5 shows the case where mover 4A is positioned substantially at the middle point and FIG. 6 shows the case where mover 4A arrives at the top dead point. Inner yoke 3 has first teeth section 31 and second teeth section 32, and faces magnet 5 of mover 4A. An advantage of the present invention exists in the condition satisfying the following relation: L2<L1<L2+L4, where L1 is a dimension of magnet 5 in a thickness direction, L2 is a dimension of a tip of the teeth in a thickness direction, L3 is a dimension of a smaller facing portion between magnet 5 and the teeth, and L4 shows a dimension of the space between tips of the teeth.

In this condition, when mover 4A is at the midpoint as shown in FIG. 5, dimension L3 is available, and when mover is at the bottom dead point or the top dead point as shown in FIG. 6, dimension L3 is not available.

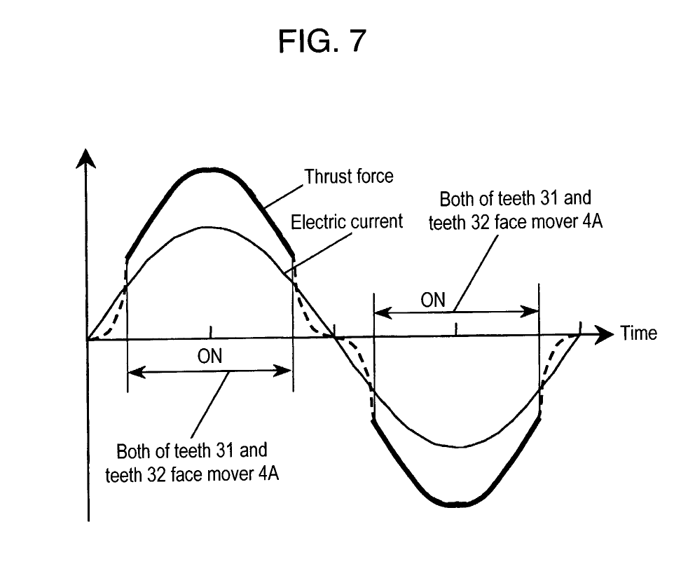

FIG. 7 shows a relation between the electric current in sine waveform supplied to coil 2 and thrust force. In the region where mover 4A faces both of first teeth section 31 and second teeth section 32 as shown in FIG. 5, attraction and repulsion occur at teeth 31 and teeth 32 with respect to magnet 5 of mover 4A. Thus thrust force can be always produced proportionate to the electric current. On the other hand, in the region where magnet 5 does not face second teeth section 32 as shown in FIG. 6, attraction and repulsion do not work efficiently at second teeth section 32 that does not face mover 4A. Thus thrust force proportionate to the current value cannot be obtained as shown in FIG. 7, and only loss increases. A similar phenomenon occurs when mover 4A arrives at the bottom dead point.

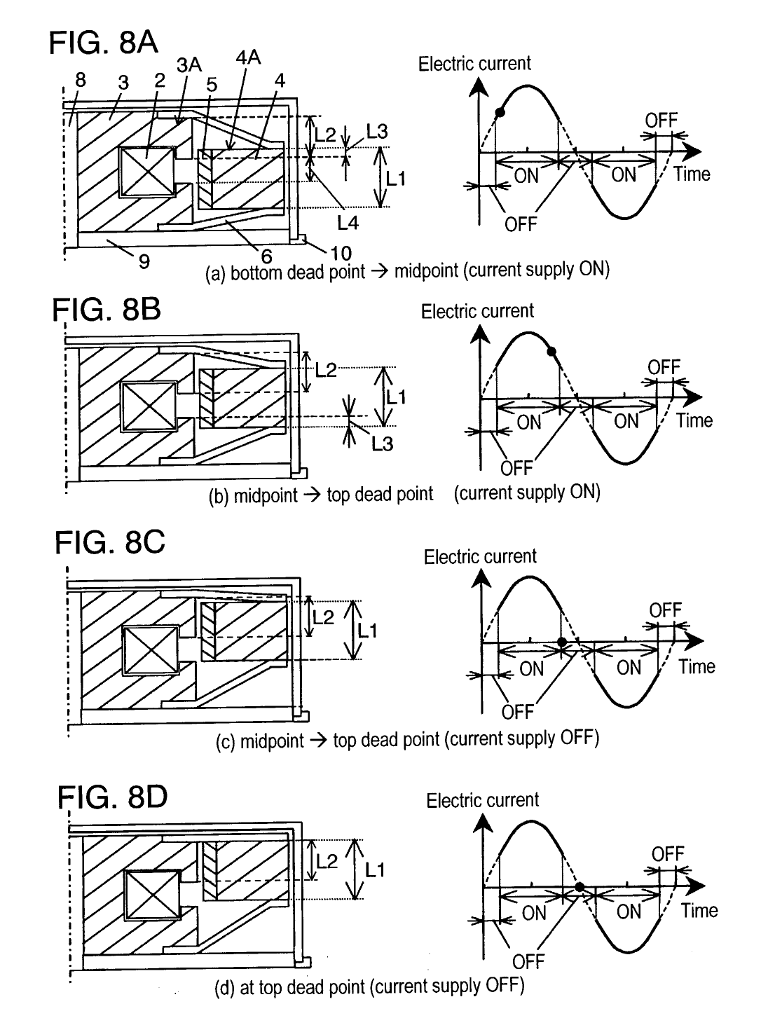

FIGS. 8A through 8D show a half cycle of mover 4A traveling from the bottom dead point to the top dead point and the status of electric current supplied correspondingly. In each waveform, a current supplying period is shown with a solid line and a non-current supplying period is shown with a broken line. A current value corresponding to a position of mover 4A is indicated with a black circle. As those drawings show, when dimension L3, i.e., the smaller facing portion between magnet 5 and the teeth, is available, the current is supplied. When dimension L3 is not available, the current is not supplied.

To be more specific, in the period where no current is supplied, an induction voltage waveform of coil 2 is observed, thereby assuming a position of mover 4A, and a beginning and an ending of supplying current in each cycle are determined. Thus when mover 4A is near the top or bottom dead point, current supply is halted, so that production of surplus loss can be prevented.

When the electric current is supplied to coil 2, thrust force vibrating up and down is applied to mover 4A; however, when the current is not supplied, inertial force is applied to mover 4A until it arrives to the top or the bottom dead point. When mover 4A arrives at the top or the bottom dead point, restoring force of elastic body 6 for returning mover 4A to the initial position is applied to mover 4A. Thus mover 4A keeps vibrating even the current is not supplied all the time.

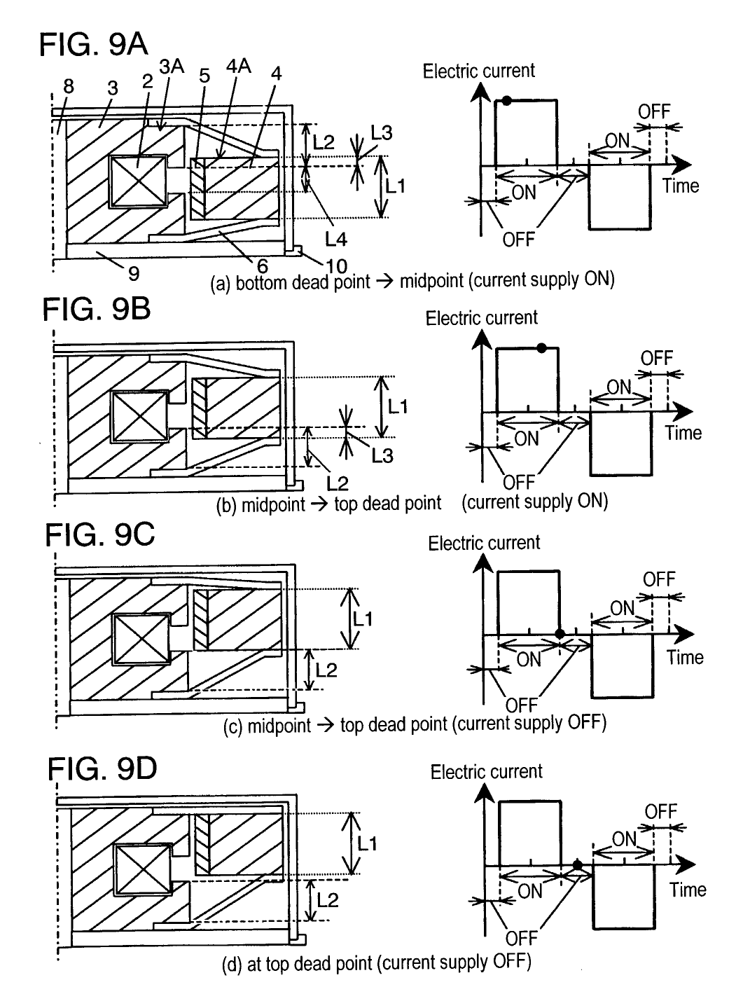

FIG. 9A through FIG. 9D illustrate a half cycle of mover 4A traveling from the bottom dead point to the top dead point and the status of electric current correspondingly supplied in rectangular waveform. This case shows similar phenomena to those when sine wave current is supplied as discussed above, thus the description is omitted.

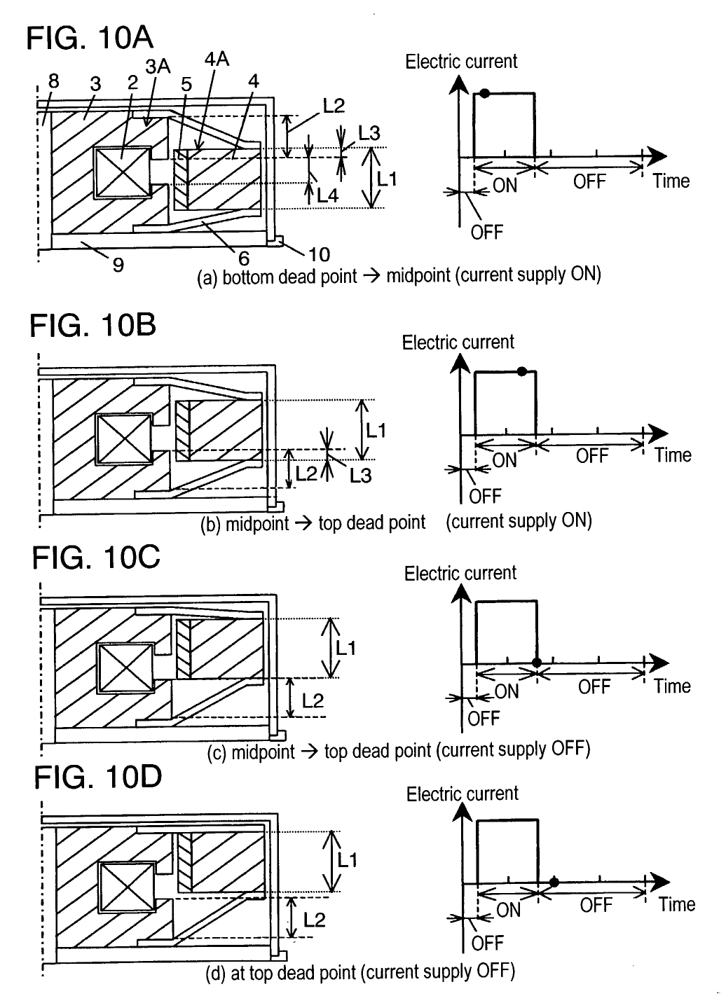

FIGS. 10A through 10D show a half cycle of mover 4A traveling from the bottom dead point to the top dead point and the status of electric current correspondingly supplied in half rectangular waveform as shown in the drawings; however, sine waveforms can be shown instead.

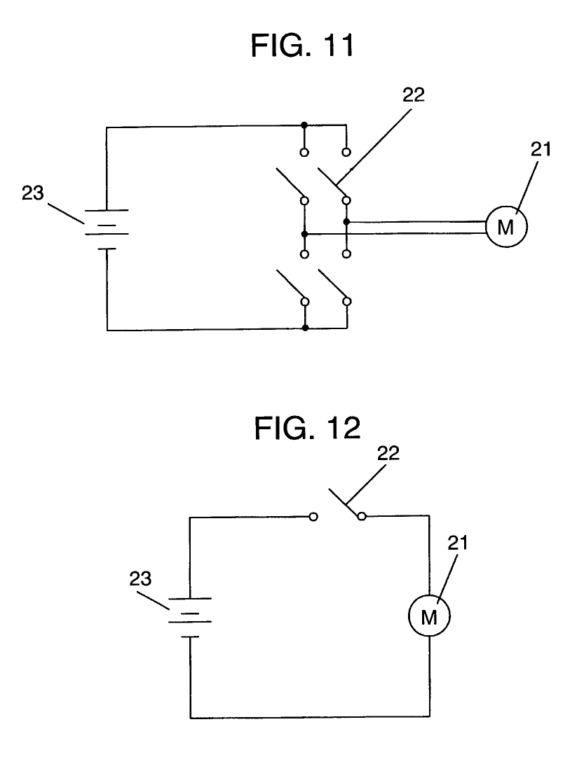

FIGS. 11 and 12 illustrate driving circuits, each one of which comprises coil 21 of the vibrating linear actuator, switching elements 22, and dc power supply 23. In the case of full-wave driving, four pieces of switching elements 22 are required as shown in FIG. 11; however in the case of half-wave driving, one switching element can work enough, so that the cost can be lowered.

Exemplary Embodiment 2

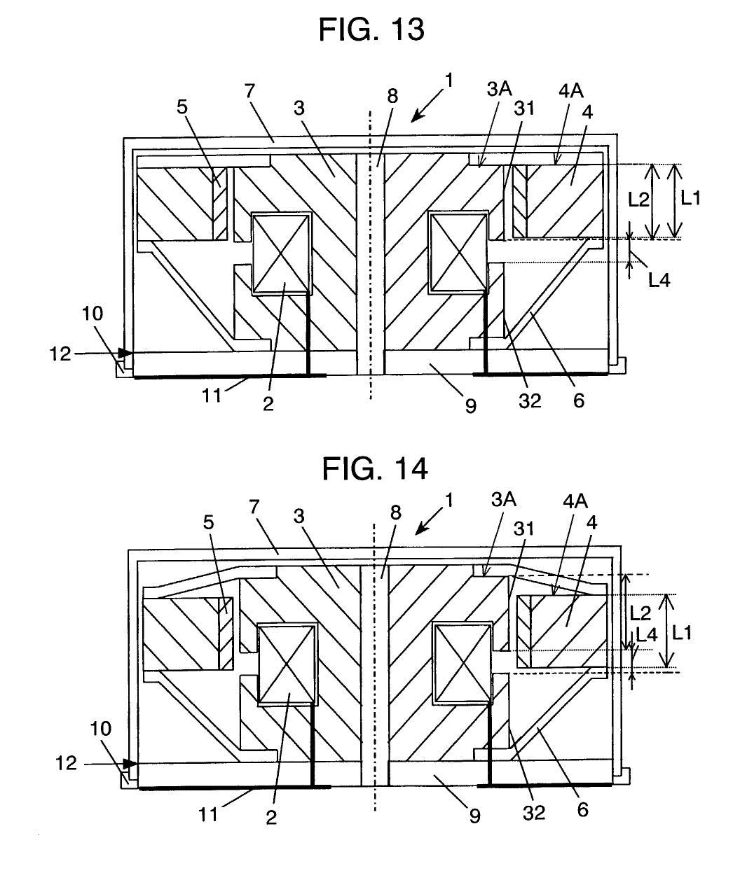

FIG. 13 and FIG. 14 illustrate an exemplary embodiment where a thickness of mover 4A is further thinned and a thickness of each tooth is further thinned in order to slim down a vibrating linear actuator. Similar elements to those in the first embodiment have the same reference marks in the drawings, and the descriptions of those elements are omitted here. This embodiment is valid when the relation of L1<L2 is satisfied.

As shown in FIG. 13, when mover 4A arrives at the top or bottom dead point, magnet 5 of mover 4A stays completely within a width of teeth 31 or teeth 32. In this status, when current is supplied to coil 2, attraction and repulsion cancel each other within the teeth, so that no thrust force is produced. As shown in FIG. 14, in the region where magnet 5 of mover 4A does not face parts of either one of first or second teeth section, the current-supply to coil 2 does not produce the thrust force efficiently.

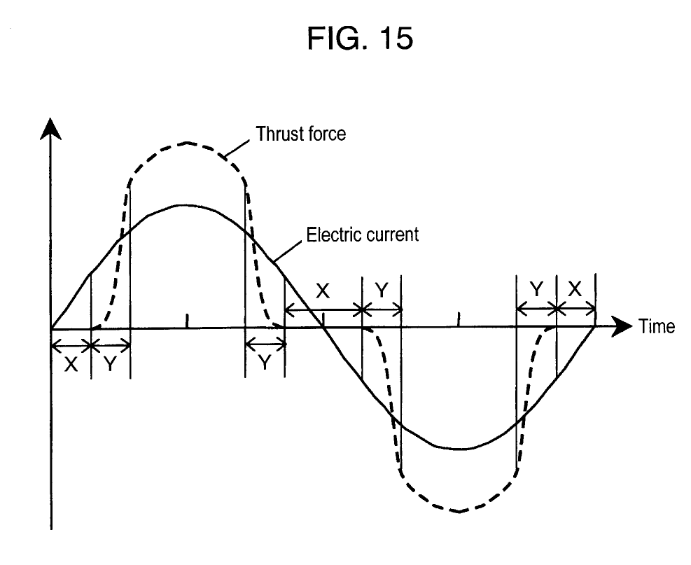

FIG. 15 shows a relation between sine-wave current supplied to coil 2 and thrust force generated. In region X, mover 4A is in a status shown in FIG. 13, i.e., mover 4A faces only either one of first teeth section 31 or second teeth section 32. No thrust force is generated in this region. In region Y, mover 4A is in a status shown in FIG. 14, i.e., mover 4A does not face either one of first teeth section 31 or second teeth section 32. In this region, thrust force is generated in a low efficiency.

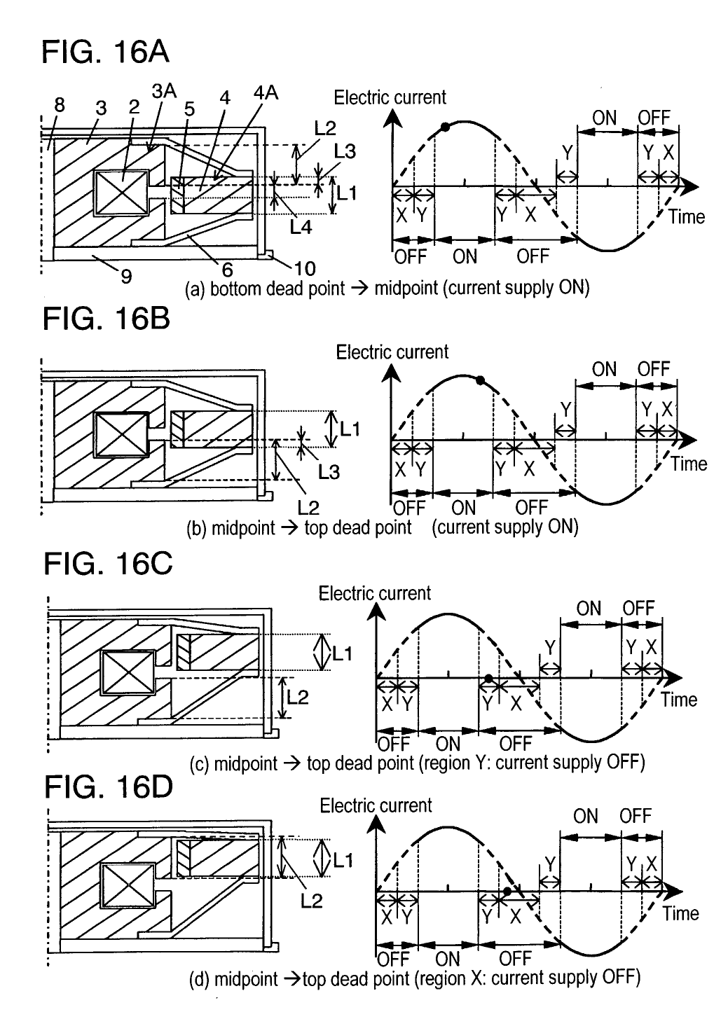

FIG. 16A through FIG. 16D illustrate a quarter cycle of mover 4A traveling from a balanced point to the top dead point and the status of electric current correspondingly. In each waveform, a current supplying period is shown with a solid line and non-current supplying period is shown with a broken line. A current value corresponding to a position of mover 4A is indicated with a black circle. As those drawings show, when dimension L3, i.e., the smaller facing portion between magnet 5 and the teeth, is available, the current is supplied. When dimension L3 is not available, the current is not supplied. In other words, no current is supplied to both of regions X and Y. Thus when mover 4A is near the top or bottom dead point, current-supply is halted, so that production of surplus loss can be prevented.

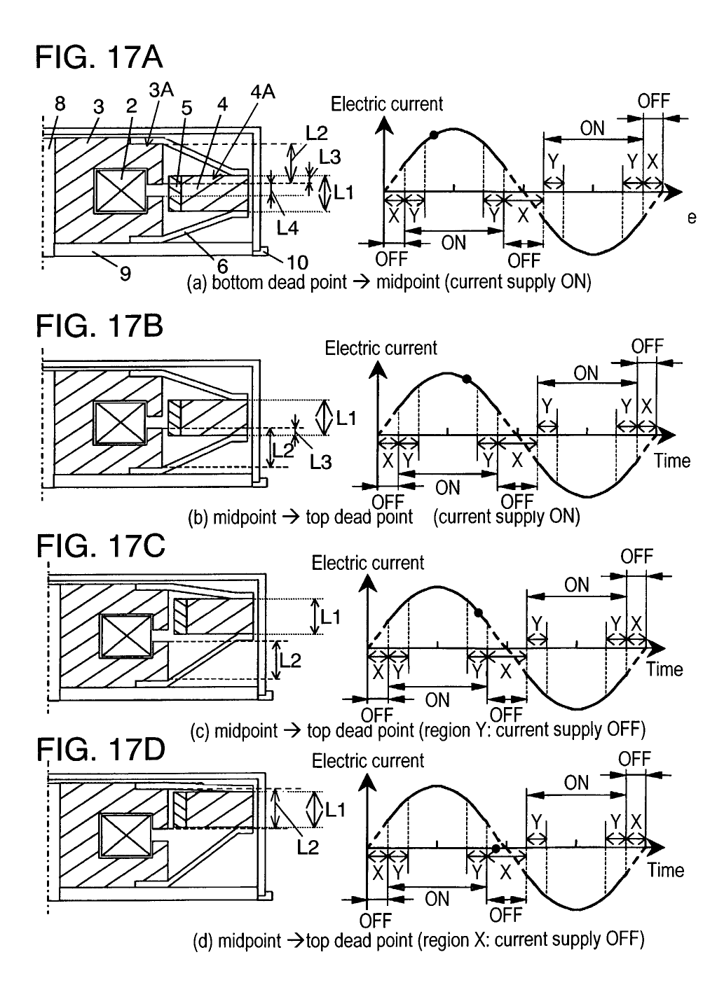

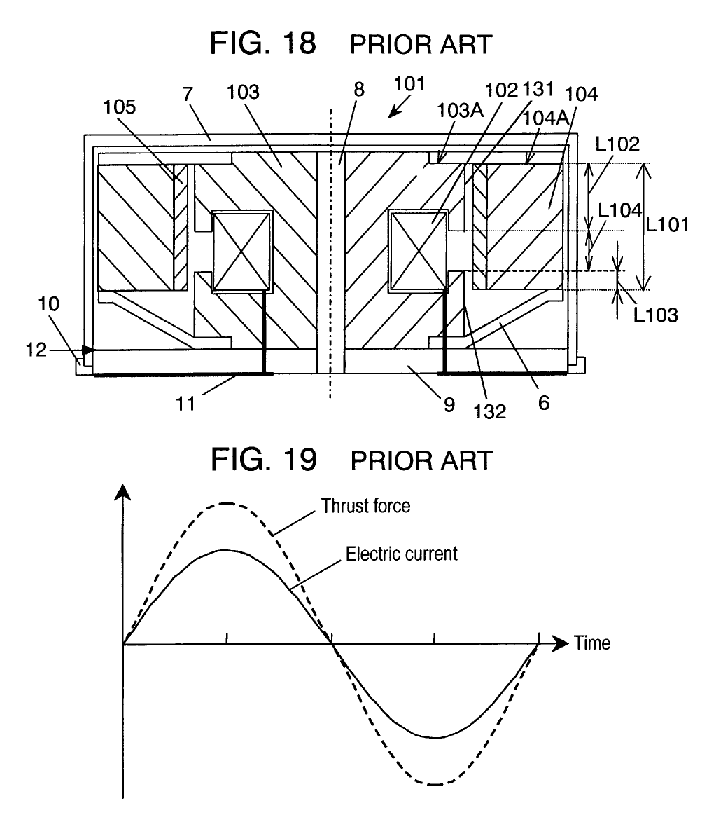

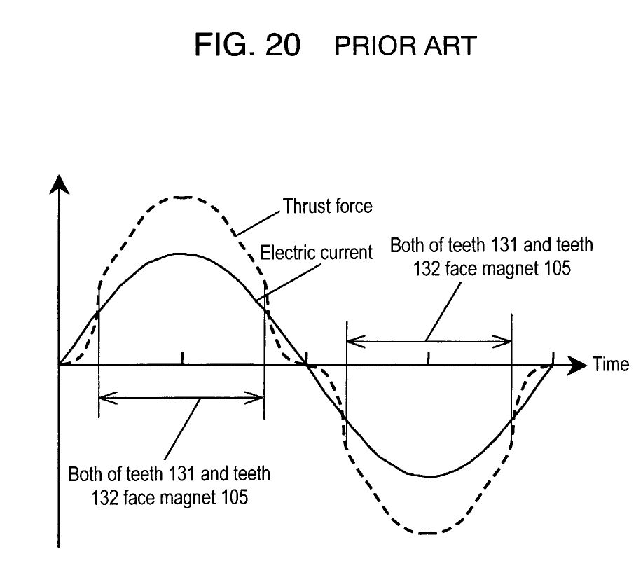

FIG. 17A through FIG. 17D illustrate phenomena similar to those discussed above; however, no electric current is supplied to region X, while electric current is supplied to region Y. In this case, although thrust force is generated at low efficiency, greater magnitude of vibration can be advantageously obtained.

In this second embodiment, the waveform of electric current supplied to coil 2 can be rectangular instead of sine curve, and half-wave driving can work well instead of full-wave driving, as proved in the first embodiment. The second embodiment thus proves that the actuator can be further slimmed down and when mover 4A is near the top or bottom dead point, current supply is halted, so that production of surplus loss can be prevented.

What is claimed is:

1. A vibrating linear actuator comprising:
(a) a mover including a permanent magnet;
(b) a stator including a first teeth section and a second teeth section, and sandwiching a coil that generates vibrating magnetic field to said mover; and
(c) an elastic body for linking said stator to said mover and energizing said mover substantially to a midpoint between the first and the second teeth sections,
wherein when said mover faces both of the first and the second teeth sections, electric current is supplied to the coil, and when said mover faces one of the first teeth section and the second teeth section, no electric current is supplied to the coil.

2. The vibrating linear actuator of claim 1, wherein the electric current supply to the coil can move said mover to a position where said mover faces only one of the first teeth section and the second teeth section.

3. The vibrating linear actuator of claim 1, wherein the electric current is supplied to the coil in both directions.

4. The vibrating linear actuator of claim 1, wherein the electric current is supplied to the coil in one direction with intermittent waveform.

5. A vibrating linear actuator comprising:
(a) a mover including a permanent magnet;
(b) a stator including a first teeth section and a second teeth section, and sandwiching a coil that generates vibrating magnetic field to said mover; and
(c) an elastic body for linking said stator to said mover and energizing said mover substantially to a midpoint between the first and the second teeth sections,
wherein when at least a part of said mover exists within a space between the first and the second teeth sections, electric current is supplied to the coil, and when said mover faces only one of the first teeth section and the second teeth section, no electric current is supplied to the coil.

6. The vibrating linear actuator of claim 5, wherein the electric current supply to the coil can move said mover to a position where said mover does not face the coil.

7. The vibrating linear actuator of claim 5, wherein the electric current is supplied to the coil in both directions.

8. The vibrating linear actuator of claim 5, wherein the electric current is supplied to the coil in one direction with intermittent waveform.

9. A portable information apparatus comprising:
a board; and
a vibrating linear actuator, mounted to said board, including;
a mover including a permanent magnet;
a stator including a first teeth section and a second teeth section, and sandwiching a coil that generates vibrating magnetic field to said mover; and
an elastic body for linking said stator to said mover and energizing said mover substantially to a midpoint between the first and the second teeth sections,
wherein when said mover faces both of the first and the second teeth sections, electric current is supplied to the coil, and when said mover faces one of the first teeth section and the second teeth section, no electric current is supplied to the coil.

10. A portable information apparatus comprising:
a board; and
a vibrating linear actuator, mounted to said board, including:
a mover including a permanent magnet;
a stator including a first teeth section and a second teeth section, and sandwiching a coil that generates vibrating magnetic field to said mover; and
an elastic body for linking said stator to said mover and energizing said mover substantially to a midpoint between the first and the second teeth sections,
wherein when at least a part of said mover exists within a space between the first and the second teeth sections, electric current is supplied to the coil, and when said mover faces only one of the first teeth section and the second teeth section, no electric current is supplied to the coil.
